(19) United States
(12) Patent Application Publication
(10) Pub. No.: US 2009/0151498 A1
(43) Pub. Date: Jun. 18, 2009

(54) STEERING COLUMN ARRANGEMENT FOR VEHICLES

(75) Inventors: Kay Garbrecht, Hamburg (DE); Holger Kittler, Hamburg (DE); Hanno Lox, Elmshorn (DE); Sven Sagner, Hamburg (DE); Joerk Tatulinski, Hamburg (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/281,270

(22) PCT Filed: Feb. 24, 2007
(86) PCT No.: PCT/EP2007/001608

§ 371 Date: Dec. 2, 2008

(30) Foreign Application Priority Data
Mar. 1, 2006 (DE) 10 2006 009 304.6

(51) Int. Cl. B62D 1/18

(52) U.S. Cl. 74/493

(57) ABSTRACT

A steering column arrangement for motor vehicles includes a steering column designed to be changeable in terms of its inclination and/or length and a clamping system having plate packs for fixing the steering column in a specific position. The steering column arrangement is designed for increasing the frictional force in the clamping system and/or for locking the clamping system, preferably by way of form-fitting engagement, with structure that acts automatically when a threshold load, acting on the steering column in the direction of its longitudinal axis, is exceeded.

### BACKGROUND AND SUMMARY OF THE INVENTION

This invention relates to an improved steering column arrangement.

In modern vehicle construction, steering columns are formed such that they can be changed in terms of their inclination and in terms of their length for ease of use. As a result, they can be adjusted to the individual requirements of a driver. In order to fix the steering column in its position, clamping means are provided. These are designed such that they reliably and permanently prevent a change in the position of the steering column. This particularly applies in the event where a force acting in the axial direction is applied onto the steering column in certain situations such as, for example, in the case of an accident. On the other hand, the clamping means must be designed such that they, where required, easily enable a change in the position of the steering column, i.e. in particular with a relatively small actuating force. Insofar as a continuously variable adjustment of the steering column is desired, its fixing in the specific position is practically performed exclusively via the frictional engagement achieved by means of the clamping means.

A steering column arrangement of the type discussed here is disclosed by European document EP 0 802 104 A1. This arrangement has a steering column and a vehicle-fixed console on which clamping means having plates are provided. The steering column is connected to the vehicle-fixed console via these clamping means. In an opening position of the clamping means, it is possible to shift the steering column relative to the console. In a closing position of the clamping means, the steering column is fixed relative to the console.

An object of the invention is to create a steering column arrangement of the type indicated above in which the clamping means ensure high functional reliability along with simultaneously good ease of use.

In order to achieve this object, a steering column arrangement with certain features is proposed for motor vehicles. The arrangement includes a console which can be arranged in a fixed manner on the vehicle, a steering column having a steering column jacket, and a steering gear shaft rotatably mounted therein and changeable in terms of its inclination and/or length. A first plate pack fixed on the console and a second plate pack fixed on the steering column jacket, in each case, have at least one plate, and the plates of the first and second plate packs intersect one another. Moreover, a clamping system which interacts with the plate packs is provided. With help from the clamping system, an increase or reduction in the pressure prevailing between the plates of the first and second plate packs is possible. As a result, a frictional engagement can be produced between the plates for the purpose of fixing the steering column. The frictional engagement can be suspended for the purpose of adjustment of the steering column. In this steering column arrangement, means for increasing the frictional force in the clamping system and/or for locking the clamping system, preferably by means of form-fitting engagement, are provided. These means act automatically when a threshold load acting on the steering column in the direction of its longitudinal central axis is exceeded. Due to this configuration, the steering column arrangement may be designed such that it ensures a high load absorption in the event of a crash along with simultaneously low actuating force for steering column locking by means of the clamping system during an adjustment for ease of use.

In a particularly preferred embodiment of the steering column arrangement, the means are formed by having at least one plate of the first plate pack fixed on the steering column jacket provided with a defined deformation zone in which the plate is deflected in the transverse direction to the longitudinal central axis of the steering column in the fixed state of the steering column when a threshold load acting on the steering column in the direction of its longitudinal central axis is exceeded, for example, in the event of a crash. As a result, above a specific load threshold, a plastic deformation of the clamping system or parts thereof thus takes place, namely at least of the first plate pack which leads at least to increased friction in the clamping region between the first and second plate packs and optionally, in the case of a further deformation, to a form-fitting engagement in the clamping system. As a result, it is ensured that, despite a relatively small actuating force, a high load absorption of the same in the event of a crash takes place for the clamping system. In this embodiment of the steering column arrangement, as a result of a corresponding design, a shorter route of the steering column in the event of a crash is used so that parts of the clamping system can deform. This means that the steering column or parts thereof are moved in the fixed state of the steering column relative to the console, which enables lateral deflection of the first plate pack. An exemplary embodiment of the steering column arrangement is furthermore preferred in which the deformation zone of the at least one plate of the first plate pack is formed such that the plate buckles when the threshold load is exceeded. The first plate pack is therefore acted on via the steering column, preferably in the region of a connection point of the first plate pack on the steering column jacket, with a compressive force, wherein the clamping system prevents a movement of the first plate pack and thus also of the steering column. After the threshold load is exceeded, a lateral deflection of the at least one plate of the first plate pack occurs, which is accompanied by a corresponding shift of the steering column. The lateral deflection of the first plates brings about at least an increase in the friction in the clamping region between the plate packs.

In order to restrict the lateral deflection of the at least one plate of the first plate pack and thus stop the movement of the steering column in the direction of the clamping system, restriction means, which can be formed, for example, by a separate stop, are provided in one advantageous exemplary embodiment of the steering column arrangement. One embodiment in which this stop is integrated into a connection point of the first plate pack on the steering column jacket is particularly preferred, as explained in greater detail below with reference to the drawings.

The defined deformation zone of the at least one plate of the first plate pack can, for example, be achieved by a suitably designed geometry as a function of the minimally required threshold load for the steering column. The deformation zone or the buckling or outward-bending region of the plate of the first plate pack can, for example, be formed by providing the plate with an offset or a weakness, in particular a weakened line or locally reduced material thickness. It is also possible to have this deformation zone spontaneously develop automatically only in the event of a crash, namely if the first plate pack is quasi clamped between a connection point on the steering column, i.e. the steering column jacket and the clamping region of the clamping system, until the deflection of the plate pack takes place in the transverse direction to the displacement direction of the steering column once the threshold load is exceeded.

The first plate pack can comprise a plurality of plates. In this case, it may be sufficient that only one of the plates has, or only a few, but not all of these plates have, a defined deformation zone as described above. Those plates which have no such deformation zone are pushed away practically under compulsion in the escape direction by the plates which escape laterally in the event of a crash and have such a deformation zone. In one advantageous embodiment of the steering column arrangement, in order to reduce the variety of parts, all plates of the first plate pack have such a deformation zone and are also otherwise formed identically.

Further advantageous embodiments of the steering column arrangement will become apparent from combinations of the features which are apparent from the claims, the specification, and the drawings.

The invention is explained below in greater detail with reference to an exemplary embodiment shown in the drawings of the steering column arrangement.

### BRIEF DESCRIPTION OF THE DRAWINGS

FIG. 1A shows a top view of an exemplary embodiment of the steering column arrangement according to the invention in the normal state, i.e. before a crash, in a schematic view;

FIG. 1B shows a section of the steering column arrangement according to FIG. 1A in the region of a first plate pack which is fastened at two connection points to a steering column jacket and is shown in a highly schematic form;

FIG. 2 shows a side view of the steering column arrangement according to FIG. 1A;

FIG. 3 shows a section of the steering column arrangement according to FIGS. 1A and 2 in a lower view after a collision;

FIG. 4 shows two views of the first plate pack according to FIGS. 1A and 1B;

FIG. 5 shows a section of the steering column arrangement according to FIGS. 1A to 3 in a connection region of the first plate pack to a steering column jacket; and

FIG. 6 shows a diagram in which the progression of the axial force acting in a steering column as a function of the displacement path of the steering column jacket in the event of a crash over time t is shown.

### DETAILED DESCRIPTION OF THE INVENTION

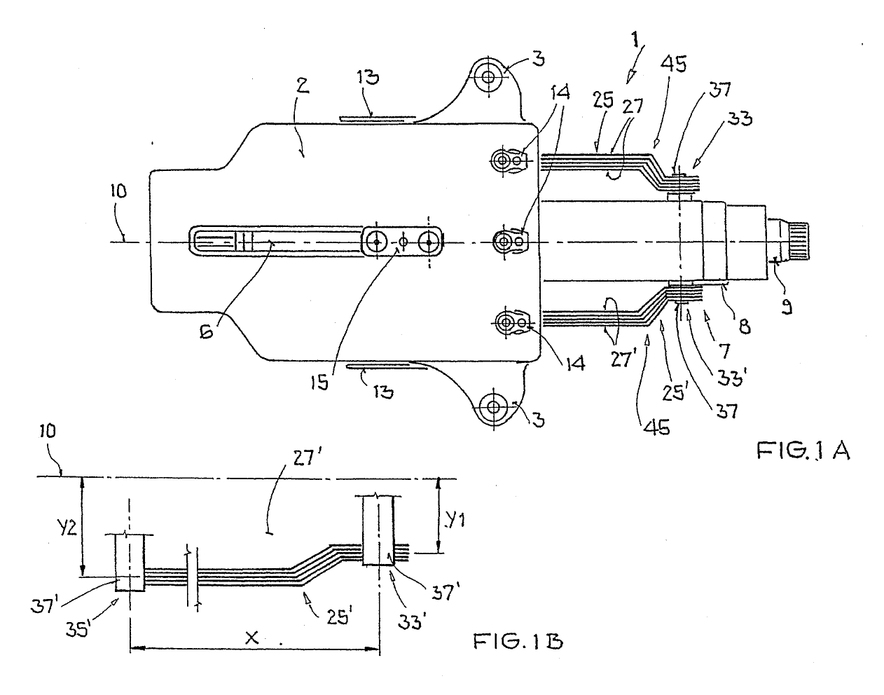

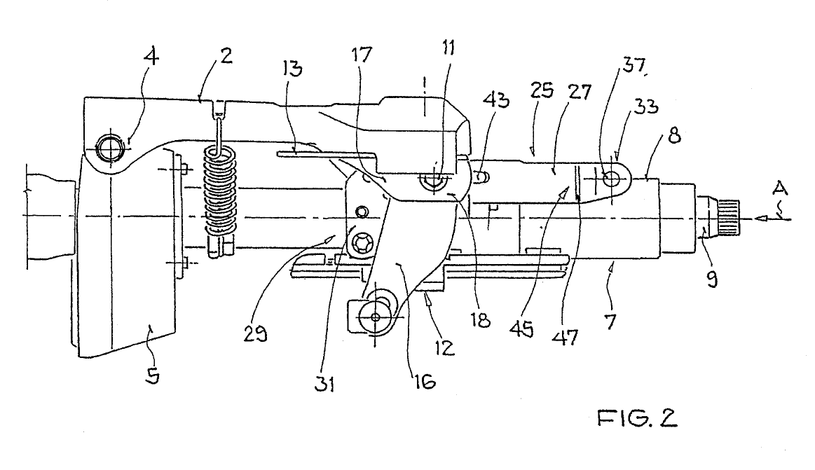

FIG. 1A shows a steering column arrangement 1. Steering column arrangement 1 has a console 2. Console 2 has an essentially rectangular cross-section. It has receptacles 3 for fastening means, not shown in greater detail. Console 2 is mounted on a vehicle, also not shown, via these fastening means. Furthermore, receptacles 4, which are visible in FIG. 2, are provided which serve to receive a further fastening element.

The fastening element arranged in receptacle 4 is used to fasten a sleeve 5 which is not of further interest in relation to the invention. Console 2 furthermore has a longitudinal hole 6 which extends over a majority of the length of console 2. The function of longitudinal hole 6 is explained in even greater detail below.

Steering column arrangement 1 furthermore has a steering column 7 with a steering column jacket 8 and a steering gear shaft 9 rotatably mounted in steering column jacket 8. Steering gear shaft 9 is used to receive a steering wheel, not shown, and to transmit a rotational movement introduced by a driver into the steering wheel onto a steering gear. Longitudinal central axis 10 of steering column 7 is shown by a dashed line.

A console slide 13 is arranged below console 2. Console slide 13 is connected via fastening elements 14 and a sliding block 15 to the console. Sliding block 15 is adapted to the dimensions of longitudinal hole 6 in terms of its dimensions and is arranged therein. It is connected via suitable fastening elements such as, for example, screws, to console slide 13.

Console slide 13 is formed preferably U-shaped and has—as is apparent from FIG. 3—parallel limbs 21 and 23, between which steering column jacket 8 is arranged. In this exemplary embodiment, limbs 21, 23 have different thicknesses, but can be of equal thickness in a different exemplary embodiment of steering column arrangement 1. Steering column jacket 8 lies here with its lateral flanks on the inside of limbs 21, 23.

Longitudinal hole recesses which are not apparent in the figures are positioned in the lateral flanks of steering column jacket 8 above the longitudinal central axis of steering gear shaft 9. The longitudinal hole recesses are arranged congruently to one another and run parallel to the longitudinal axis of steering column jacket 8. A clamp bolt 11 running transverse to the longitudinal axis of steering column jacket 8 is guided through these longitudinal hole recesses, which bolt 11 projects beyond limbs 21, 23 on both sides Clamp bolt 11 is part of a clamping system 12 for fixing of steering column 7 on console 2 or console slide 13. The structure and the function of such a clamping system 12 is generally known, for example, from German document DE 103 18 034 A1 and European document EP 0 802 104 B1, whose content in this regard is made the subject matter of this specification such that this is only discussed briefly below.

On the outsides of limbs 21, 23, a first plate pack 25 or 25′, comprising respectively a plurality of plates 27 or 27′ arranged spaced apart from one another, and respectively a second plate pack 29 or 29′, comprising respectively a plurality of plates 31 or 31′ arranged spaced apart from one another, are provided. The configuration of respectively first plate packs 25, 25′ and second plate packs 29, 29′ and their arrangement relative to one another and their respective connection to steering column jacket 8 or console 2 are identical such that this is described below solely with reference to first and second plate packs 25 and 29.

Plates 27 of first plate pack 25 are retained on steering column jacket 8 via a first connection point 33 and a second connection point 35. Connection points 33, 35 are embodied as a slot mortise joint. To this end, retaining bolts 37, which protrude laterally from steering column jacket 8 in the radial direction and are arranged in a fixed position, are provided on steering column jacket 8 and passage openings 39 and 41 are provided on plates 27. In this case, passage opening 39 for first connection point 33 is adapted to the size and shape of retaining bolt 37 such that first plates 27 and steering column jacket 8 are coupled to one another by form-fitting engagement, preferably substantially free of play. Second passage opening 41 is formed as a longitudinal hole recess whose longitudinal axis runs parallel or substantially parallel to the longitudinal central axis of steering column 7 and to the longitudinal hole recesses in steering column jacket 8 penetrated by clamp bolt 11. Second passage opening 41 can alternatively also be formed by a recess or the like which is open at the end side and is slit-shaped.

Plates 27 furthermore have a passage opening which is formed as a longitudinal hole recess 43 whose longitudinal axis runs parallel or substantially parallel to the longitudinal axis of steering column 7, wherein longitudinal hole recesses 43 of plates 27, 27′ are arranged congruently to longitudinal hole recesses in steering column jacket 8 and are penetrated by clamp bolt 11.

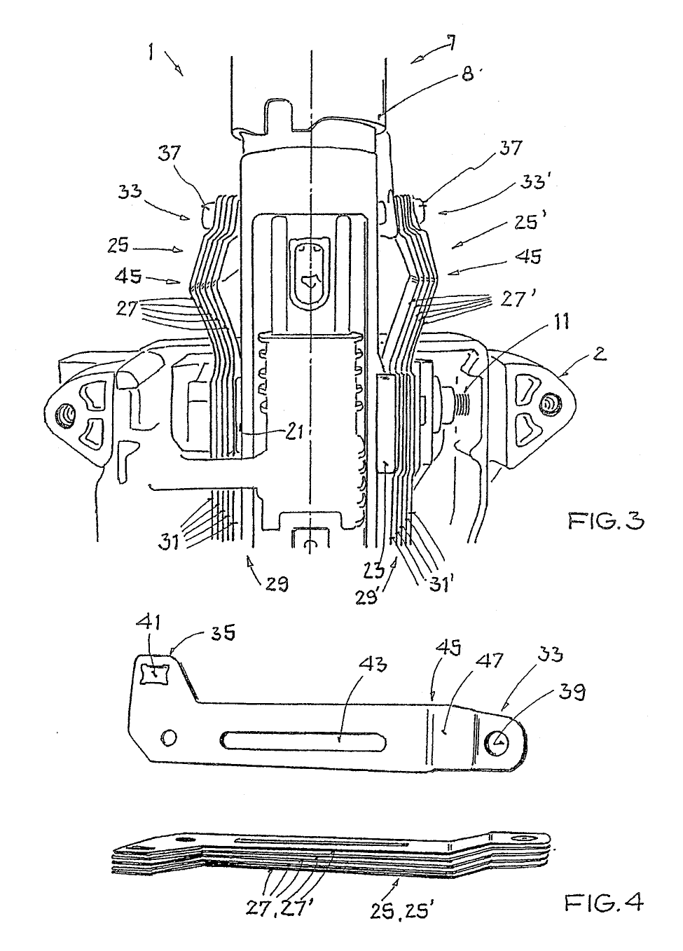

Plates 27 have, in the region between first connection point 33 on steering column jacket 8 and longitudinal hole recess 43, a defined deformation zone 45 in which plates 27 are deflected in the transverse direction to the longitudinal axis of the steering column in the fixed state of steering column 7 when a threshold load acting on steering column 7 in the direction of its longitudinal central axis (arrow A in FIG. 2) is exceeded. The respective deformation zone 45 is, in the case of the exemplary embodiment shown in the figures, achieved by an offset 47, i.e. as an angular bending of otherwise flat, disk-shaped plates 27, as is particularly apparent from FIG. 4. Other variants for achieving such a deformation zone are possible.

As is apparent from FIG. 1B, offset 47 of plates 27, 27′ is embodied such that connection points 33, 33′ and 35, 35′ have different distances Y1 or Y2 to longitudinal central axis 10 of steering column 7. Distances Y1 and Y2 are here central distances, i.e. measured between a plate which lies in the center of the plate pack and longitudinal central axis 10. In this exemplary embodiment, it is provided that connection points 33, 33′ have a smaller distance to longitudinal central axis 10 than connection points 35, 35′. The different distances, i.e. the radial offset of the connection points of plates 27, 27′ to the steering column jacket, bring about a particularly reliable, defined outward bending of plates 27, 27′ in the event of a crash when a predetermined threshold load is exceeded due to the offset introduction of force into the steering column jacket. By varying the distance between the imaginary planes running perpendicular to the image plane of FIGS. 1A and 1B in which the first and second connection points are located, a defined adjustment of the preferably smoothly running escape movement of plates 27, 27′ is possible in the event of a crash and the direction in which the plates buckle/are deflected.

It must still be stated that plate packs shown in FIGS. 1A and 1B with the plates having a deformation zone 45 are shown in a highly schematic form in order to clarify in particular the arrangement of deformation zone 45 on the plates. Such a pronounced deformation zone—as shown—is not absolutely necessary at least not in all cases. This means that deformation zone 45 can, for example, be formed by a slight offset, such as for example shown in FIG. 4, or the like.

Plates 31 of second plate pack 29 are fixed on console 2, in the exemplary embodiment according to the figures indirectly via console slide 13, at at least one connection point, i.e. held in a fixed position. Plates 31 have in the familiar manner in each case a passage opening, which is not apparent in the figures, through which clamp bolt 11 is guided. Insofar as steering column 7 should only be adjustable in terms of its length, this passage opening is only so large that clamp bolt 11 engages through this with a small degree of play. Insofar as steering column 7 should also be adjustable in terms of its inclination, this passage opening is formed by a longitudinal hole running in the vertical direction according to the view of FIG. 2.

Plates 27, 31 of first and second plate packs 25, 29 are arranged in a sandwich-like manner relative to one another, i.e. within intersecting plate packs 25, 29, and in each case a plate of one plate pack alternately follows a plate of the other plate pack, wherein the plates are aligned relative to one another such that their passage openings cross one another for passing through of clamp bolt 11.

Clamping system 12 comprises, in addition to the plate packs and clamp bolt 11, in a familiar manner also a pressure plate arranged at one end of clamp bolt 11 protruding beyond the plate packs and fixed on clamp bolt 11. Moreover, at the other end of clamp bolt 11, a tensioning element and a manually and/or motively actuable tension lever 16 is provided which is also pivotable around an axis. In this case, the tensioning element is formed such that, in the event of a swiveling of tension lever 16 in a first direction, the contact pressure between plates 27, 31 and 27′, 31′ is increased. A frictionally engaging/clamping connection is formed as a result, which fixes steering column 7 in a desired position. The clamping region is located in the convergence region of plates 27, 31 and 27′, 31′ relative to one another. In this case, limbs 21, 23 can also be formed on console slide 13 to be bendable such that further frictional pairings are formed between the insides of these limbs and the lateral flanks of the steering column jacket which is particularly preferred.

For adjustment for the ease of use of steering column 7, i.e. its adaptation in terms of its length and optionally its inclination with respect to the vehicle driver, the clamping must be released. To this end, tension lever 16 is correspondingly swiveled in the other direction, as a result of which the contact pressure acting between plates 27, 31 and 27′, 31′ is reduced. The embodiment described above of clamping system 12 is naturally only one of many possible solutions in relation to the increase or reduction in the contact pressure between the plates. The invention is not restricted to this.

Irrespective of the respective structural configuration of the clamping system, one particularly important function of clamping system 12 in the case of steering column arrangement 1 according to the invention lies in the fact that the contact pressure acting between plates 27, 31 and 27′, 31′ can be adjusted to be large enough so that this frictional engagement connection is sufficiently large for forces which occur at least in normal use of steering column arrangement 1 so that steering column 7, in the desired position, is connected via console 2 to a vehicle body support structure immovably, preferably free of play. In this case, however, the actuating forces to be applied manually by the driver for fixing or release of the clamping connection in the case of a steering column 7 which is formed to be manually adjustable should be low for reasons of ease of use. In order to satisfy these two conditions and to ensure that in the event of a crash in which the loads acting on steering column 7 are significantly increased, the clamping connection does not release, the plates of first plate packs 27, 27′are respectively provided with deformation zone 45 described above.

The mode of operation of steering column arrangement 1 according to the invention in the context of the exemplary embodiment shown in the figures is explained in greater detail below. If, in the event of a crash, for example a frontal collision of the motor vehicle with an obstruction, a force A indicated in FIG. 2 by an arrow acts on steering column arrangement 1 and this force A exceeds a predetermined level, plates 27, 27′ buckle laterally outward in the region of their deformation zone 45. This means that the retaining/frictional forces applied in the clamping region of clamping system 12 are sufficiently large that plates 27, 27′—as described above—can deform in the desired manner. In this case, steering column jacket 8 is shifted against the frictional force prevailing in the clamping region between its lateral flanks and the insides of the limbs of the console slide and against the deformation of plates 27, 27′ in the X-direction, i.e. in the direction of longitudinal central axis 10 of steering column 7. In this case, the prior displacement of steering column jacket 8 first enables the desired deformation of plates 27, 27′ and is thus an important structural prerequisite for the function of the system according to the invention in the case of the exemplary embodiment described with reference to the figures. As a result of the preferably plastic, i.e. non-reversible deformation of plates 27, 27′ preferably manufactured from metal, in particular sheet metal material, by lateral escape while reducing its total length, the frictional force acting against the load in clamping system 12 is at least significantly increased. According to a further development of the invention, the deformation of plates 27, 27′ leads to a form-fitting engagement in clamping system 12 and thus to a locking of the same. An unintentional release of the frictional engagement connection achieved by means of clamping system 12, in the event of a crash, can therefore be reliably prevented even in the case of a relatively small actuating force for clamping system 12 for adjustment for ease of use.

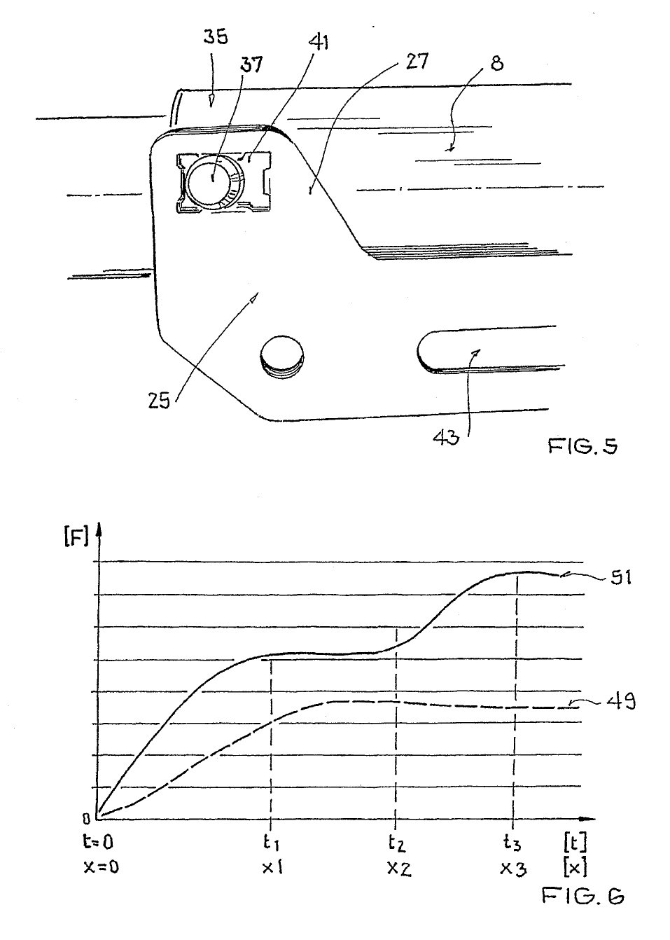

FIG. 3 shows steering column arrangement 1 in a state in which steering column jacket 8 is displaced in the case of fixed steering column 7 so far relative to console 2 that the deformation of plates 27, 27′ of first plate packs 25, 25′, has a maximum. So that the buckling out of plates 27, 27′ is restricted to a specific level, restriction means are provided in the case of the exemplary embodiment according to FIGS. 1 to 5, which restriction means are formed here as path restriction means which interact with steering column jacket 8. These path restriction means are formed by the length of second passage openings 41 formed as a longitudinal hole recess in the region of second connection point 35 of first plates 27, 27′, against which wall retaining bolts 37 run according to a path X1, which retaining bolts 37 are provided on steering column jacket 8 and at least protrude into or engage through these passage openings 41. In FIG. 5, a further movement of steering column jacket 8 in the x-direction is prevented by abutment of retaining bolts 37 against a lateral wall of passage opening 41. Steering column arrangement 1 is designed in this case such that, until the conclusion of deformation of plates 27, 27′, the connection between console slide 13 and console 2 remains in place.

Once clamping system 12 is secured by targeted deformation of parts of the same against an undesired detachment, force A is furthermore introduced via steering gear shaft 9, steering column jacket 8 and clamping system 12 into console slide 13. Therein, clamping device 12 is designed such that it withstands the predetermined level of force at least until the deformation of plates 27, 27′ is concluded. If force A now exceeds a predetermined level, fastening elements 14 detach between console slide 13 and console 2 which has the result that a movement of console slide 13 relative to console 2 is now enabled As a result of the interaction of sliding block 15 connected to console slide 13 and longitudinal hole 6 of console 3, console slide 13 performs a defined linear movement predetermined by longitudinal hole 6. Steering column arrangement 1 according to the invention accordingly provides two possibilities of shifting steering column 7 in the vehicle. One possibility is provided after release of clamping device 12 for the purpose of the adjustment of steering column 7 for ease of use; a further after release of fastening elements 14 in the event of a crash. As a result of the provision of two separate shift or adjustment possibilities, it is possible to adjust the resistances which have to be overcome during shifting of steering column arrangement 1 in various ways. If, in the event of an accident, a force A now acts on steering column arrangement 1 and this acts via steering gear shaft 9, the steering column jacket and clamping device 12 on console slide 13, fastening elements 14 release and enable a movement of console slide 13 relative to console 2.

FIG. 6 shows a diagram in which the progression of the axial force acting in steering column 7 is shown as a function of displacement path X of steering column jacket 8 in the event of a crash over time t. In this case, force F acting in the axial direction in steering column 7 is plotted on the y-axis and time t, beginning with a displacement path X=0 of steering column jacket 8 in the event of a crash, on the x-axis. Characteristic line 49 shows the progression of force in the steering column of a conventional steering column arrangement in which no means according to the invention are provided to increase the frictional force in clamping system 12 or to lock clamping system 12. In contrast to this, a characteristic line 51 shows the progression of force in steering column 7 of steering column arrangement 1 according to the invention. It is apparent that force F initially rises in steering column 7 between starting position x=0) of steering column jacket 8 at t=0 until steering column jacket 8 is displaced by distance X1 until time t1. Steering column 7 is only deformed in the elastic range within displacement path X1 of the steering column jacket. In this range, the forces correspond approximately to the normal operational load. Once steering column jacket 8 has passed through position X1, it moves up to position X2 defined by the path restriction means at time t2 with lateral deflection of plates 27, 27′ as described above. Force F in steering column 7 remains substantially constant during the displacement of steering column jacket 8 with simultaneous outward bending of plates 27, 27′. After deformation of plates 27, 27′, in the case of steering column jacket 8 positionally fixed by means of path restriction means, the force in steering column 7 rises significantly once again until it substantially has a maximum up at a time t3. Approximately at time t3, the connection between console slide 3 and console 2 is detached so that console slide 13 with steering column jacket 8 attached thereon is released for displacement relative to console 2.

It must still be stated that characteristic line 51 shown in FIG. 6 can be influenced by various different parameters.

In the case of an exemplary embodiment, not shown in the figures, of the steering column arrangement, a plate pack pairing, comprising first and second plate packs 25 and 29 or 25′ and 29′, is provided only on one side. Two first and second plate packs therefore need not absolutely necessary in each case be provided on both sides of steering column jacket 8.

The restriction means can also be formed by a stop which interacts directly or indirectly with plates 27 or 27′ for adjustment of the lateral outward bending of the plates of the first plate pack as an alternative to the exemplary embodiment described with reference to the figures. For example, this stop could prevent a further deformation of plates 27, 27′ adjusted according to a certain displacement path of the steering column jacket so that the crash forces are introduced back into the console after abutment of plates 27, 27′ against the stop without the steering column jacket moving in the process at least until the connection of the console slide is detached from the console.

In summary, in the case of steering column arrangement 1 according to the invention, a targeted deformation of at least parts of clamping system 12 takes place relative to the console slide with the help of a displacement movement of steering column jacket 8 and indeed in the case of axial forces (arrow A in FIG. 2) acting on steering column 7, which the frictional engagement connection achieved by means of clamping system 12 between first and second plate packs still withstands. Only after the increase in the clamping forces in the clamping region or a locking of the clamping system has taken place and the axial force exceeds a threshold which can be adjusted by structural measures, the force- and/or form-fitting connection between console slide and console is detached such that steering column 7 is displaced away from the driver in the desired manner.

1-13. (canceled)

14. A steering column arrangement for a vehicle, comprising:
a console that can be fixed on the vehicle,
a steering column that has a steering column jacket and a steering gear shaft rotatably mounted therein, the steering column being changeable in terms of its inclination, its length, or both its inclination and its length,
a first plate pack, fixed on the console, and a second plate pack, fixed on the steering column jacket, each of the plate packs having at least one plate, the plates of the first and second plate packs intersecting one another,
a clamping system for fixing the steering column in a specific position by correspondingly increasing a contact pressure prevailing between the plates in at least a part of an overlap region, and
means for at least one of increasing a frictional force in the clamping system and locking the clamping system that act automatically when a threshold load, acting on the steering column in the direction of its longitudinal central axis, is exceeded.

15. The steering column arrangement as claimed in claim 14, wherein the means are formed so that at least one plate of the first plate pack has a defined deformation zone, in which the plate is deflected in the transverse direction to the longitudinal central axis of the steering column in the fixed state of the steering column when a threshold load acting on the steering column in the direction of its longitudinal central axis is exceeded.

16. The steering column arrangement as claimed in claim 15, wherein the first plate pack has a plurality of plates that all have such a deformation zone.

17. The steering column arrangement as claimed in claim 16, wherein the plates of the first plate pack are formed identically.

18. The steering column arrangement as claimed in claim 15, wherein the deformation zone of the at least one plate is formed such that the plate buckles when the threshold load is exceeded.

19. The steering column arrangement as claimed in claim 15, further comprising restriction means provided to restrict the lateral deflection or outward bending of the at least one plate.

20. The steering column arrangement as claimed in claim 19, wherein the deformation zone is arranged in the region between a connection point of the plates of the first plate pack with the steering column jacket and the clamping region of the first and second plate packs.

21. The steering column arrangement as claimed in claim 15, wherein the at least one plate of the first plate pack is fixed on the steering column jacket via a first connection point and a second connection point, which are arranged at a distance to one another in the direction of the longitudinal axis of the steering column, and wherein a tension means for increasing and reducing the contact pressure prevailing between the plates is arranged in the region between the connection points.

22. The steering column arrangement as claimed in claim 14, wherein the at least one plate of the first plate pack is formed or angled such that the radial distance of the first and second connection points from the longitudinal central axis of the steering column is of varying size.

23. The steering column arrangement as claimed in claim 22, wherein the radial distance of the first connection point from the longitudinal central axis of the steering column is smaller than the radial distance of the second connection point.

24. The steering column arrangement as claimed in claim 21, wherein the deformation zone of the at least one plate of the first plate pack is provided in the region between the first connection point and the clamping region.

25. The steering column arrangement as claimed in claim 21, wherein at least the second connection point is formed as a slot mortise joint, and wherein the slot is a longitudinal hole recess with a longitudinal axis that runs at least approximately parallel to the longitudinal central axis of the steering column.

26. The steering column arrangement as claimed in claim 21, wherein the first connection point is formed such that the first plate pack and the steering column jacket are coupled to one another by way of form-fitting engagement.

27. The steering column arrangement as claimed in claim 14, wherein the means for at least one of increasing the frictional force and looking the clamping system operates with form-fitting engagement.
